(19) United States
(12) Patent Application Publication
(10) Pub. No.: US 2006/0208478 A1
(43) Pub. Date: Sep. 21, 2006

(54) Self-adhesive label and method for the manufacture thereof

(75) Inventor: Ralf Schneitter, Basel (CH)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Stralfors AB

(21) Appl. No.: 11/377,025

(22) Filed: Mar. 16, 2006

(30) Foreign Application Priority Data
Mar. 17, 2005 (EP) 05 005 814.8

(51) Int. Cl. B42D 15/00

(52) U.S. Cl. 283/81

(57) ABSTRACT

The present invention relates to a self-adhesive label for labeling containers, preferably containers for pharmaceutical preparations having a cylindrical or other shape. The self-adhesive label (1) comprises a lower part (4), an upper part (5) and at least one intermediate part (7), whereby the lower part (4) has at least one printed information (16) on an upper side and the upper part (5) has at least one printed information (17) on an upper side. The lower and upper parts (4, 5) are connected to each other while they consist of a folded label strip (2). The invention also relates to a method for manufacturing such a self-adhesive label.

### FIELD OF THE INVENTION

The present invention relates to a self-adhesive label for labeling containers, preferably containers for pharmaceutical preparations having a cylindrical or other shape. The self-adhesive label consists of a single label strip and includes a lower part, an upper part and at least one intermediate part, whereby the lower part has at least one printed information on an upper side and the upper part at least one printed information on an upper side.

The invention also relates to a method for manufacturing such a self-adhesive label.

### BACKGROUND OF THE INVENTION

Self-adhesive labels consisting of a single label strip which is folded into different parts, are already known from e.g. WO 01/52223 and EP 0346567. However, these prior art self-adhesive labels are not folded in a material-saving manner and have no sub-labels.

### SUMMARY OF THE INVENTION

The object of the present invention is to provide a self-adhesive label at which the above drawbacks are eliminated. This is arrived at primarily by means of the characterizing features of subsequent claim 1 and, regarding the manufacture of the self-adhesive label, primarily by means of the characterizing measures of subsequent claim 25.

The self-adhesive label according to the present invention is folded in a material-saving manner and it comprises a sub-label which does not complicate opening or closing of the self-adhesive label.

### BRIEF DESCRIPTION OF THE DRAWINGS

The invention will be described below with reference to the accompanying drawings, in which:

FIG. 1 is an enlarged side view of parts of a closed self-adhesive label according to the invention;

FIG. 2 is a top plan view of the self-adhesive label of FIG. 1;

FIG. 3 is a bottom plan view of the self-adhesive label of FIG. 1;

FIG. 4 illustrates the self-adhesive label of FIG. 1 after opening thereof;

FIG. 5 illustrates the self-adhesive label of FIG. 1 on a cylindrical container for pharmaceutical preparations;

FIG. 6 is a side view of another embodiment of the self-adhesive label according to the invention; and

FIG. 7 is a schematic view of a part of an adhesive-application device during application of adhesive on self-adhesive labels of FIG. 1.

### DESCRIPTION OF EXAMPLE EMBODIMENTS

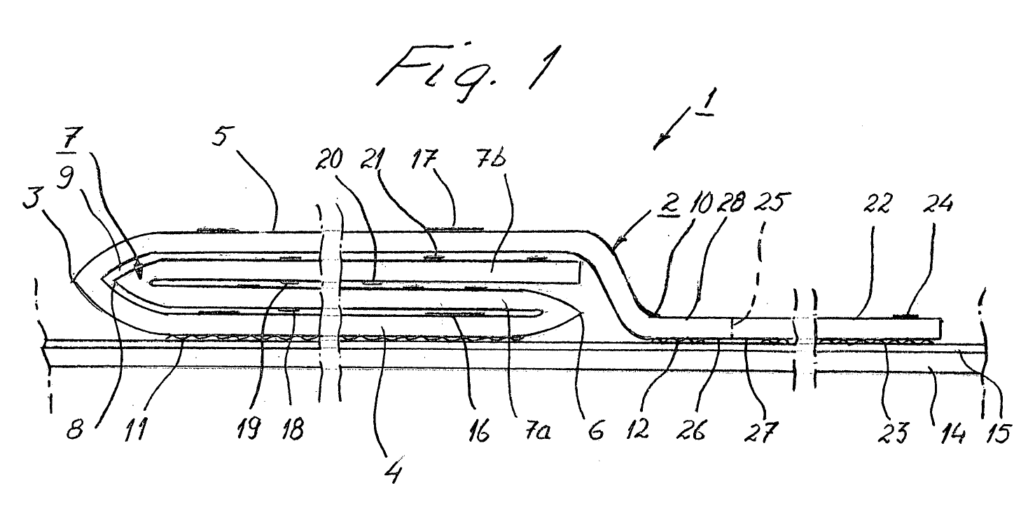

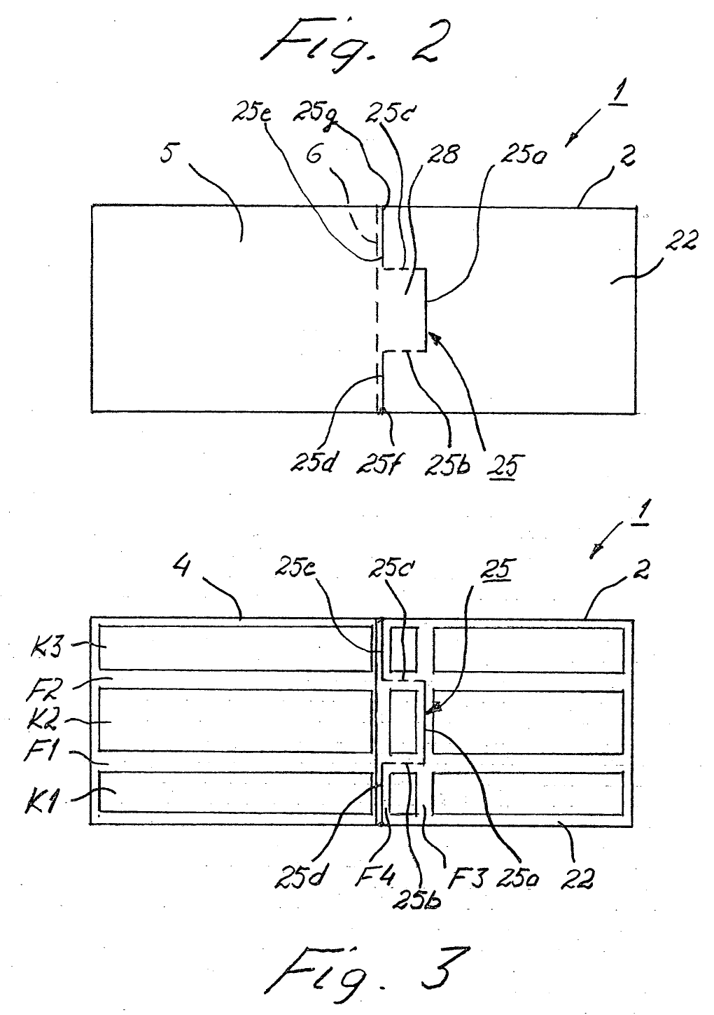

The self-adhesive label 1 illustrated in FIGS. 1-5 consists of a label strip 2, all sections of which consist of one and the same material, e.g. paper material or substantially paper material. The label strip 2 is by means of a rear transverse folding line 3 folded into a lower part 4 and an upper part 5. The label strip 2 is by means of a front folding line 6 also folded into an intermediate part 7, which is situated between the lower and upper parts 4, 5. The intermediate part 7 may include one portion or, by folding the label strip 2 along one or more transverse folding lines 8, include two or more, e.g. six portions, of which only two portions 7a, 7b are shown.

As is apparent from, inter alia, FIG. 1, the intermediate part 7 is located in a space 9 between the lower and upper parts 4, 5 and this space 9 is closed from behind by the lower and upper parts 4, 5. At the front, the upper part 5 has a closing portion 10 which extends above front portions of the lower part 4 and which is provided to close and reopen the space at the front thereof.

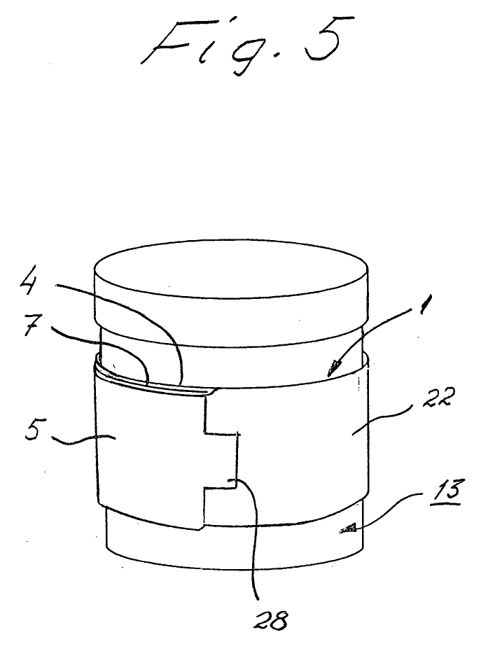

The lower part 4 is on its bottom or lower side provided with at least one adhesive layer 11 and the closing portion 10 at least one adhesive layer 12. These adhesive layers 11, 12 are provided for applying the self-adhesive label 1 onto a container 13 (see FIG. 5) of cylindrical or similar shape, e.g. a container for pharmaceutical preparations.

In FIG. 1, the self-adhesive label 1 is shown not on the container 13 but on a dispenser foil 14, whereby the adhesive layers 11, 12 are provided easily releasable on a silicone layer 15 on the dispenser foil 14, such that the self-adhesive label 1 can be removed from the dispenser foil 14 without loosing the function of the adhesive layers 11, 12.

The lower part 4 has printed information 16 on its upper side and the upper part 5 has printed information 17 on an upper side.

The printed information 16 on the lower part 4 is preferably identical (or almost identical) with the printed information 17 on the upper part 5. These printed informations are also preferably at least partly colour prints which preferably have the same tints or tones on the lower and upper parts 4, 5.

The intermediate part 7, or intermediate portions 7a, 7b, preferably have printed information 18-21 on the upper and/or lower sides or surfaces. These printed informations 18-21 are preferably at least partly colour prints which preferably have the same tints or tones.

The printed information on the lower and upper parts 4, 5 and preferably also on the intermediate part 7 can be printed by means of a printing procedure, e.g. an offset printing procedure.

The label strip 2 can also form a sub-label 22 which is directly or indirectly connected to the closing portion 10. The sub-label 22 has at least one adhesive layer 23 on its bottom or lower side and printed information 24 on its upper side.

The sub-label 22 can be separated at least partly from the closing portion 10 by means of a separating line 25, such that the closing portion 10, for opening of the self-adhesive label, can be grasped, separated from the sub-label 22 and removed from the container 13.

The separating line 25 is provided on a front portion of the closing portion 10 and the bottom or lower side of said closing portion 10 preferably has a surface free from adhesive along the separating line 25, such that no adhesive is found at said separating line and the closing portion is easier to grasp and remove. Preferably, the lower side of the sub-label 22 also has a surface 27 free from adhesive along the separating line 25.

The closing portion 10 may have different shapes at the front. A preferred shape is at least one tongue 28 which extends forward, whereby the sub-label 22 has such a shape that the tongue 28 fits therein. At this embodiment, the separating line 25 may have a section 25a which extends transverse to the longitudinal direction of the label strip 2 as well as two substantially in said longitudinal direction extending sections 25b, 25c in order to define the tongue 28.

The separating line 25 may in this embodiment also comprise two sections 25d, 25e which extend transverse to said longitudinal direction from the sections 25b, 25c to the respective outer edge of the closing portion 10. Instead of the sections 25b, 25c, 25d, 25e, two sections may extend obliquely from the section 25a to the respective outer edge of the closing portion 10.

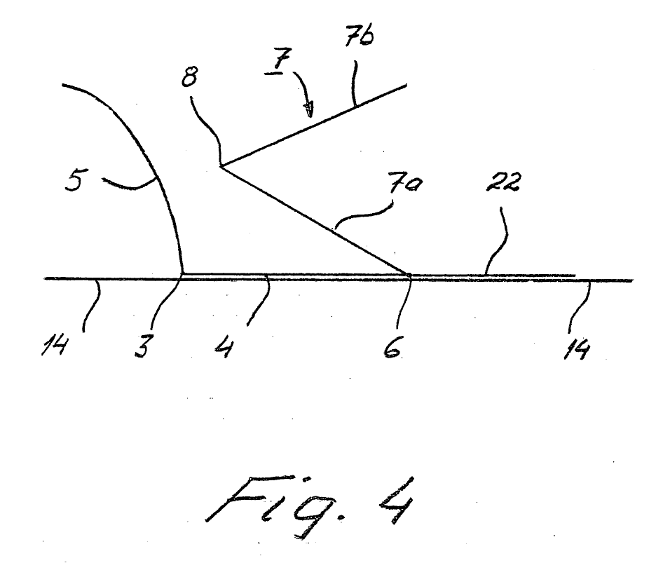

The adhesive layers 11, 12 and 23 on the lower part 4, the closing portion 10 and the sub-label 22 may be provided as a plurality of, e.g. three, adhesive strips K1, K2 and K3 which extend adjacent each other in the longitudinal direction, defining between them longitudinal surfaces F1 and F2 without adhesive (FIG. 3).

The surfaces F1 and F2 are preferably situated such that the sections 25b, 25c of the separating line 25 can be found therein. Hereby, said sections 25b, 25c are located in surfaces free from adhesive.

The adhesive strips K1, K2 and K3 are preferably interrupted at two locations such that two surfaces F3 and F4 free from adhesive and extending transverse to the longitudinal direction are defined. In one of the surfaces F3 without adhesive is preferably the transverse section 25a of the separating line 25 located and in the other surface F4 without adhesive preferably the two sections 25d, 25e.

The separating line 25 may be a line which is punched through the label strip 2 and/or is partly a perforated line. At the illustrated embodiment, the section 25a is e.g. a punched line, the sections 25b, 25c are perforated lines and the sections 25d, 25e punched lines. The sections 25d, 25e can e.g. be connected to the closing portion 10 at points 25f, 25g.

It should also be mentioned that the entire label strip 2, i.e. all sections thereof, consists preferably of one and the same material. In the second folding line 6 between the lower part 4 and the intermediate part 7, no perforation can be provided and perforations may not be located in folding lines between different portions 7a, 7b of the intermediate part 7. The surface 26 free from adhesive on the closing portion 10 may be formed by covering an adhesive layer with a varnish or a corresponding adhesive-repellent material. This is applicable also on the other locations without adhesive on the label strip 2.

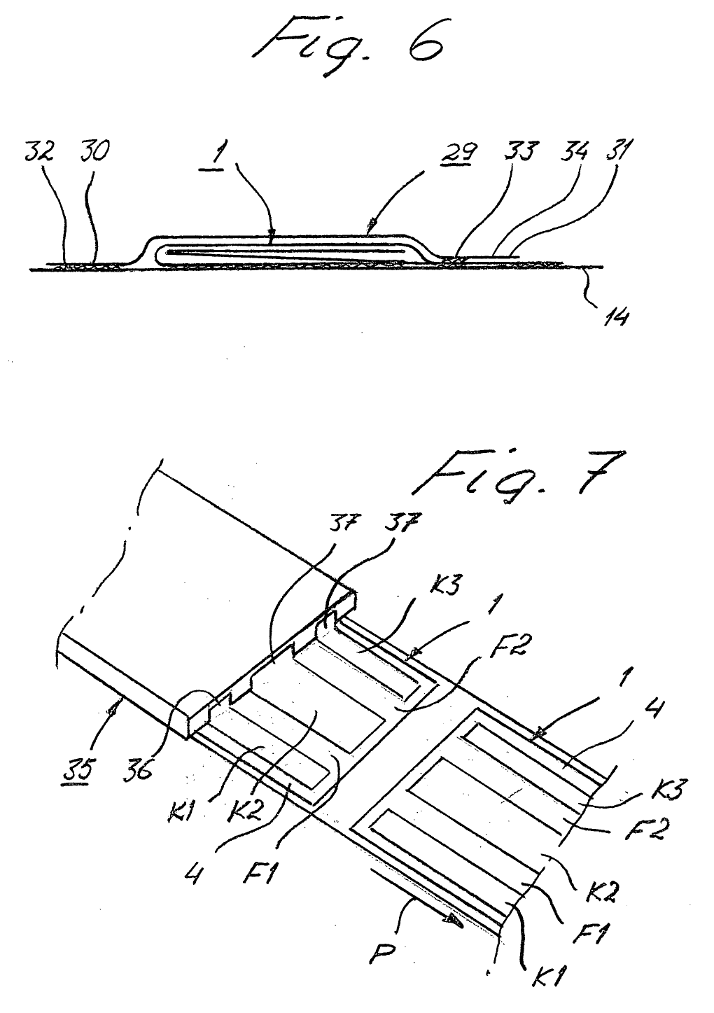

The self-adhesive label 1 may according to FIG. 6 be covered by e.g. a cover part 29. This cover part 29 may be longer than at least the upper part 5 of the self-adhesive label 1 and may have at least one such adhesive layer 32, 33 that end portions 30, 31 thereof can be removably located on the container 13 or, if there is a sub-label 22, that one 31 of the end portions 30, 31 is removably provided on the sub-label 22. The cover part 29 can by itself or together with the separating line 25 hold the closing portion 10 and the sub-label 22 together.

A part 34 of the end portion 31 may define a grip portion without adhesive for easy grasping and removal of said end portion.

The cover part 29 is preferably transparent, may be printed upon and may consist of a plastic foil, e.g. of polyester, polypropylene or polyethylene.

The application of adhesive on the self-adhesive label 1 can be carried through e.g. in the following manner:

Self-adhesive labels 1 are transported on a transport device T with the lower sides turned upwards and relative to an adhesive-application device 35 in the direction of an arrow P in FIG. 7. The adhesive-application device 35 is provided with a predetermined number of discharge openings, in the illustrated embodiment three discharge openings 36, 37, 38, through which adhesive is discharged and applied onto said lower sides. Thus, in the illustrated embodiment, three adhesive strips K1, K2 and K3 are applied onto the lower sides. Hereby, the surfaces F1 and F2 without adhesive are defined. In order to define the transverse surfaces F3, F4, the application of the adhesive is interrupted for a short time.

After application of the adhesive layers 11, 12, 23, the self-adhesive labels 1 are mechanically positioned one after the other on the silicone layer 15 of the dispenser foil 14 and mechanically removed therefrom and placed on the containers 13.

The adhesive label 1 described above can also be used on other containers than containers for pharmaceutical preparations. Furthermore, the containers need not be cylindrical but may have other shapes. The material for the label strips may vary, as may the adhesive. The sub-label 22 may remain on the container 13 or be removed therefrom and attached to another object.

1. Self-adhesive label for labeling containers (13), preferably containers for pharmaceutical preparations having a cylindrical or other shape, wherein:
the self-adhesive label (1) includes a lower part (4), an upper part (5) and at least one intermediate part (7),
the lower part (4) has at least one printed information (16) on an upper side and the upper part (5) at least one printed information (17) on an upper side,
the lower part (4) has at least one adhesive layer (11) on a bottom or lower side in order to apply the self-adhesive label (1) on the container (13),
the intermediate part (7) is located in a space (9) between the lower and upper parts (4, 5),
the space (9) is closed by means of the lower and upper parts (4, 5) behind the intermediate part (7),
the upper part (5) includes a closing portion (10) which on a bottom or lower side has at least one adhesive layer (12) and which is provided to be directly or indirectly located on the container (13) as well as removed therefrom, and
the lower and upper parts (4, 5) are connected to each other while they consist of a folded label strip (2),
the label strip (2) is folded into the lower and upper parts (4, 5) along a transverse rear folding line (3),
the label strip (2) is folded into the lower part (4) and at least one intermediate part (7) along a front folding line (6),
the label strip (2) includes a sub-label (22) which is provided directly or indirectly at a closing portion (10) provided at the upper part (5),
the sub-label (22) has at least one adhesive layer (23) on a lower side for being able to directly or indirectly locate said sub-label (22) on the container (13),
the sub-label (22) has printed information (24) on an upper side, and
the closing portion (10) and the sub-label (22) are at least partly separated from each other by means of at least one separating line (25).

2. Self-adhesive label according to claim 1, wherein the sub-label (22) has a surface (27) free from adhesive along the separating line (25).

3. Self-adhesive label according to claim 1, wherein the closing portion (10) has at least one tongue (28) which is defined by a separating line (25) comprising at least one section (25a) extending transverse to the longitudinal direction of the label strip (2) and at least two sections (25b, 25c, 25d, 25e) extending from said section (25a) to an outer edge of the closing portion (10).

4. Self-adhesive label according to claim 1, wherein:
adhesive layers (12, 23 and eventually 11 ) are provided at least on the lower sides of the closing portion (10) and the sub-label (22) and preferably also on the lower side of the lower part (4) as a plurality of adhesive strips (K1-K3) which extend adjacent each other in the longitudinal direction of the label strip (2),
elongated surfaces (F1, F2) free from adhesive and also extending in said longitudinal direction are defined between these adhesive strips (K1-K3), and
sections (25b, 25c) of the separating line (25) are found in the surface or surfaces (F1, F2) free from adhesive.

5. Self-adhesive label according to claim 4, wherein:
the adhesive strips (K1-K3) are interrupted at several locations in order to define surfaces (F3, F4) free from adhesive and extending transverse to the longitudinal direction of the label strip (2), and
sections (25a, 25d, 25e) of the separating line (25) are found in these transverse surfaces (F3, F4).

6. Self-adhesive label according to claim 1, wherein at least one section (25a and/or 25d, 25e) of the separating line (25) consists at least partly of a line punched through the label strip (2).

7. Self-adhesive label according to claim 1, wherein the separating line (25) includes some points (25f, 25g) through which the closing portion (10) and the sub-label (22) are connected to each other.

8. Self-adhesive label according to claim 1, wherein one or more sections (25b, 25c) of the separating line (25) are perforated lines.

9. Self-adhesive label according to claim 1, wherein the intermediate part (7) and the lower part (4) are connected to each other while they consist of the folded label strip (2).

10. Self-adhesive label according to claim 9, wherein the intermediate part (7) consists of several portions (7a, 7b) which are connected to each other while they consist of the folded label strip (2).

11. Self-adhesive label according to claim 9, wherein all sections of the label strip (2) which define the lower part (4) and the upper part (5) and preferably also the intermediate part (7) or portions, consist of one and the same material.

12. Self-adhesive label according to claim 11, wherein a perforation is provided in the front folding line (6) between the lower part (4) and the intermediate part (7) and/or in a folding line (8) between several intermediate portions (7a, 7b).

13. Self-adhesive label according to claim 1, wherein the printed informations (16, 17 and eventually 18-21) on the lower and upper parts (4, 5) as well as preferably on the intermediate part (7) are printed in a printing process.

14. Self-adhesive label according to claim 1, wherein:
printed information (16) on the lower part (4) is at least partly identical with printed information (17) on the upper part (5), and
the informations (16, 17) on the lower and upper parts (4, 5) are preferably colour printings, whereby said colour printings on said lower and upper parts (4, 5) have the same tints or tones.

15. Self-adhesive label according to claim 1, wherein a closing portion (10) of the self-adhesive label (1) includes a grip portion of which the bottom or lower side has a lower surface (26) free from adhesive.

16. Self-adhesive label according to claim 15, wherein the surface (26) tree from adhesive is defined by applying an adhesive-repellent material onto an adhesive.

17. Self-adhesive label according to claim 1, wherein at least one cover part (29) is provided to cover at least portions of the self-adhesive label (1).

18. Self-adhesive label according to claim 17, wherein the cover part (29) is removably located on the container (13).

19. Self-adhesive label according to claim 17, wherein the cover part (29) is provided to cover the upper part (5) of the self-adhesive label (1) and at least a portion of a sub-label (22).

20. Self-adhesive label according to claim 17, wherein the cover part (29) is provided to, by itself or together with other parts (25f, 25g), at least partly hold a closing portion (10) of the upper part (5) and the sub-label (22) together.

21. Self-adhesive label according to claim 17, wherein the cover portion (29) is removably provided on one hand on the container (13) and on the other hand on a sub-label (22).

22. Self-adhesive label according to claim 17, wherein a part (34) of an end portion (31) of the cover part (29) defines a grip portion free from adhesive.

23. Self-adhesive label according to claim 17, wherein the cover part (29) consists of a plastic foil of e.g. polyester, polypropylene or polyethylene.

24. Self-adhesive label according to claim 1, wherein:
the lower part (4) on a bottom or lower side has at least one adhesive layer (11) for locating or positioning the self-adhesive label (1) on the container (13),
the intermediate part (7) is situated in a space (9) between the lower and upper parts (4, 5),
the space (9) is closed by means of the lower and upper parts (4, 5) behind the intermediate part (7), and
the upper part (5) includes a closing portion (10) which on a bottom or lower side has at least one adhesive layer (12) and which is provided to be directly or indirectly located on the container (13) as well as removed therefrom.

25. Method for manufacturing a self-adhesive label (1) for labeling containers (13), preferably containers for pharmaceutical preparations having a cylindrical or other shape, wherein:
a label strip (2) is folded into a lower part (4), an upper part (5) and at least one intermediate part (7),
informations (16, 17) are printed at least on the upper sides of the lower and upper parts (4, 5), and
the self-adhesive label (1) is displaced relative to an adhesive-application device (35) or vice versa, which applies adhesive on the self-adhesive label (1) in order to define at least one adhesive layer (11, 12, 23) on parts (4, 10, 22) thereof,
parts (4, 10, 22) of the self-adhesive label (1), the adhesive-application device (35) defines a plurality of adjacent adhesive strips (K1, K2, K3) and, between said adhesive strips, surfaces (F1, F2) free from adhesive, said adhesive strips and said surfaces extending in the longitudinal direction of the label strip (2).

26. Method according to claim 25, wherein the adhesive application by the adhesive-application device (35) is interrupted in order to define at least one surface (F3, F4) free from adhesive and extending transverse to the longitudinal direction of the label strip (2).

27. Method according to claim 25, wherein through the adhesive application by the adhesive-application device (35), surfaces (F1 -F4) free from adhesive are defined in such parts of the self-adhesive label (1) in which at least one separating line (25) is located or sections (25a-25e) thereof are found.

28. Method according to claim 25, wherein:
adhesive is applied onto the lower side of the lower part (4) and on a lower side of a closing portion (10) in order to define adhesive layers (11, 12) on said lower part and said closing portion, and
adhesive is applied preferably on the lower side of a sub-label (22) in order to define an adhesive layer (23) on said lower side of said sub-label.
